(19) United States
(12) Patent Application Publication
(10) Pub. No.: US 2021/0248756 A1
(43) Pub. Date: Aug. 12, 2021

(54) IMAGE PROCESSING APPARATUS, VEHICLE-MOUNTED APPARATUS, IMAGE PROCESSING METHOD, AND PROGRAM

(71) Applicant: SONY CORPORATION, TOKYO (JP)

(72) Inventor: Masao SASAKI, KANAGAWA (JP)

(21) Appl. No.: 17/049,819

(22) PCT Filed: Feb. 14, 2019
(86) PCT No.: PCT/JP2019/005225

§ 371 Date: Oct. 22, 2020

(30) Foreign Application Priority Data
May 10, 2018 (JP) 2018-091460

(51) Int. Cl. G06T 7/223; B60R 1/00; G06K 9/00; G06T 7/292

(52) U.S. Cl. CPC G06T 7/223; B60R 1/00; G06K 9/00805; B60R 2300/8093; B60R 2300/302; B60R 2300/105; G06T 7/292

(57) ABSTRACT

An image processing apparatus includes a control portion configured to switch, in accordance with a moving speed of a mobile body, different search ranges of a motion vector set in accordance with projection characteristics of a fisheye lens.

### TECHNICAL FIELD

The present disclosure relates to an image processing apparatus, a vehicle-mounted apparatus, an image processing method, and a program.

### BACKGROUND ART

Techniques for detecting an object present in front of a vehicle using a camera mounted to the vehicle are known. For example, PTL 1 below describes a technique for detecting an object present in front of a vehicle with a camera using a fisheye lens.

### CITATION LIST

### Patent Literature

[PTL 1]

JP 2017-41100A

### SUMMARY

### Technical Problem

However, PTL 1 does not describe an object detection system that detects an object performing processing utilizing characteristics of a fisheye lens.

An object of the present disclosure is to provide an image processing apparatus, a vehicle-mounted apparatus, an image processing method, and a program which perform processing utilizing characteristics of a fisheye lens.

### Solution to Problem

For example, the present disclosure is

an image processing apparatus including:

a control portion configured to switch, in accordance with a moving speed of a mobile body, different search ranges of a motion vector set in accordance with projection characteristics of a fisheye lens.

For example, the present disclosure is

an in-vehicle device including:

a fisheye lens;

an image-capturing portion; and

a control portion configured to set a search range for detecting a motion vector based on an image obtained by the fisheye lens and the image-capturing portion, wherein

the control portion is configured to switch, in accordance with a moving speed of a mobile body, different search ranges of a motion vector set in accordance with projection characteristics of the fisheye lens.

For example, the present disclosure is

an image processing method including:

a control portion switching, in accordance with a moving speed of a mobile body, different search ranges of a motion vector set in accordance with projection characteristics of a fisheye lens.

For example, the present disclosure is

a program that causes a computer to execute an image processing method including:

a control portion switching, in accordance with a moving speed of a mobile body, different search ranges of a motion vector set in accordance with projection characteristics of a fisheye lens.

### Advantageous Effects of Invention

According to at least one embodiment of the present disclosure, processing utilizing characteristics of a fisheye lens can be performed. It should be noted that the advantageous effect described above is not necessarily restrictive and any of the advantageous effects described in the present disclosure may apply. In addition, it is to be understood that contents of the present disclosure are not to be interpreted in a limited manner according to the exemplified advantageous effects.

### BRIEF DESCRIPTION OF DRAWINGS

FIG. 1A and FIG. 1B are diagrams for explaining first projection characteristics of a fisheye lens.

FIG. 2 is a diagram for explaining second projection characteristics of a fisheye lens.

FIG. 3 is a block diagram showing a configuration example of a dashboard camera according to the embodiment.

FIG. 4 is a block diagram showing a configuration example of an image encoding portion according to the embodiment.

FIG. 5 is a diagram showing an example of divided regions in a circular fisheye image.

FIG. 6 is a diagram for explaining an example of a diagonal fisheye image.

FIG. 7 is a diagram showing an example of divided regions in a diagonal fisheye image.

FIG. 8 is a flow chart showing a flow of processing performed by the dashboard camera according to the embodiment.

FIG. 9 is a block diagram showing a configuration example of a moving body detection apparatus according to a modification.

FIG. 10 is a block diagram showing an example of a schematic configuration of a vehicle control system.

FIG. 11 is an explanatory diagram showing an example of installation positions of an external vehicle information detecting portion and an image-capturing portion.

### DESCRIPTION OF EMBODIMENTS

Hereinafter, an embodiment and the like of the present disclosure will be described with reference to the drawings. The descriptions will be given in the following order.

<Characteristics of Fisheye Lens>

<Embodiment>

<Modifications>

<Applications>

It is to be understood that the embodiment and the like described below are preferable specific examples of the present disclosure and that contents of the present disclosure are not to be limited to the embodiment and the like.

<Characteristics of Fisheye Lens>

In order to facilitate understanding of the present disclosure, first, characteristics of a fisheye lens will be described. A fisheye lens refers to a lens capable of photographing a range with a 180-degree angle of view. Although a plurality of systems for projecting a range with a 180-degree angle of view onto a photographing surface are known, in the present example, a system known as equidistant projection will be described.

One of the characteristics of a fisheye lens is that the closer to a peripheral part, the more compressed and distorted an image to be obtained. Therefore, a motion at a central part of an image tends to appear larger than in a peripheral part of the image. Meanwhile, when a fisheye lens is applied to an in-vehicle device, a field of view changes according to a one-dimensional motion of going forward or going backward which is a basic motion of a vehicle. A characteristic of a fisheye lens is that, in this case, a motion in the peripheral part of an image tends to appear larger than in the central part of the image.

(First Projection Characteristics of Fisheye Lens)

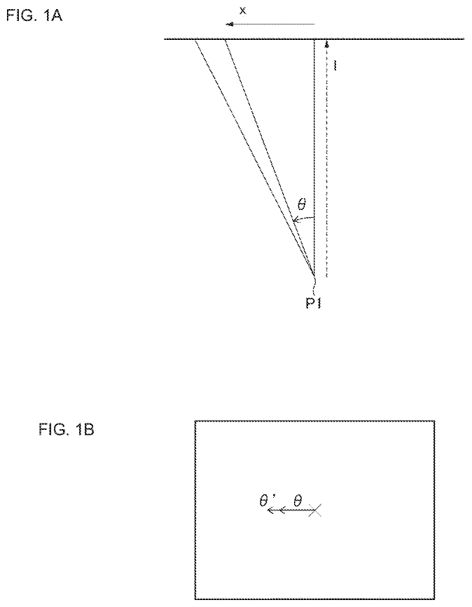

Projection characteristics of the fisheye lens indicating how a movement of an object seen through the fisheye lens is projected onto a photographing surface (onto an imaging element surface) which is a projection surface will now be described. As shown in FIG. 1A, it is assumed that an object is present on a surface separated by a distance 1 from a photographing point P1, a distance from a center of the surface to the object is denoted by x, and an angle (a visual angle) at which the object is viewed is denoted by θ. As shown in FIG. 1B, on the projection surface through the fisheye lens, x is projected at a location separated by a distance θ from a center.

In this case, the distance 1 from the center to the object on the photographing surface is proportional to the angle θ at which the object is viewed from the photographing point P1. If a movement distance of the object is denoted by x, then mathematical expression 1 below is satisfied.

[Math. 1]

x=l tan θ (1)

Based on mathematical expression 1, mathematical expression 2 below is obtained by representing a displacement dx of the object moving on a surface separated by the distance 1 from the photographing point P1 by a displacement dθ of θ.

$$\begin{matrix}[ Math . 2 ] & \\ dx = \frac{l}{{cos}^{2} θ} d θ & ( 2 )\end{matrix}$$

Mathematical expression 2 reveals the following. Relative to the displacement of θ, the displacement of x is small near θ=0 degrees (in front of the photographing point P1).

In addition, the displacement of x is large near θ=90 degrees (in a directly horizontal direction from the photographing point P1). In other words, the displacement of x is not transferred to θ.

This means that, the further away the object is from the center, the greater the compression of a movement distance of the object on the photographing surface. These projection characteristics of the fisheye lens will be referred to as first projection characteristics when appropriate.

(Second Projection Characteristics of Fisheye Lens)

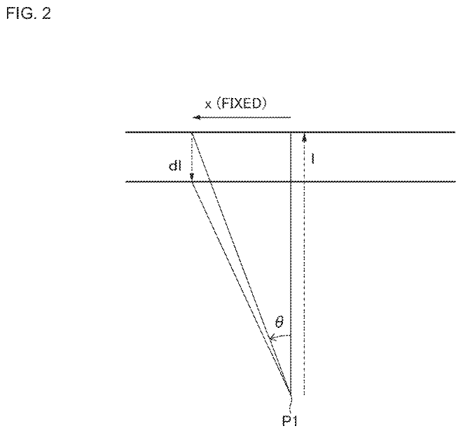

Next, a case where a photographer (for example, a mobile body such as a vehicle) approaches an object while photographing the object with a fisheye lens will be considered. As shown in FIG. 2, it is assumed that an object is present on a surface separated by a distance 1 from a photographing point P1 and a distance from a center of the surface to the object is denoted by x. The distance 1 can be represented by mathematical expression 3 below.

$$\begin{matrix}[ Math . 3 ] & \\ l = \frac{x}{tan θ} & ( 3 )\end{matrix}$$

With respect to a relationship between the distance 1 and a visual angle θ when the object is stationary (x is a fixed value), mathematical expression 4 below is satisfied.

$$\begin{matrix}[ Math . 4 ] & \\ dl = - \frac{x}{{sin}^{2} θ} d θ & ( 4 )\end{matrix}$$

From mathematical expression 4, mathematical expression 5 below is derived.

$$\begin{matrix}[ Math . 5 ] & \\ dl = - \frac{2 l}{sin 2 θ} d θ & ( 5 )\end{matrix}$$

Mathematical expression 5 reveals the following. Relative to the displacement of θ, the displacement of 1 is small near θ=45 degrees.

In addition, the displacement of 1 is large when θ=0 degrees (in front of the photographing point P1) and when θ=90 degrees (in a directly horizontal direction from the photographing point P1). In other words, the displacement of 1 is not transferred to θ.

This means that when the photographer moves forward in a state where the object is seen in a direction of 45 degrees, the object moves in an enlarged manner on the photographing surface. These projection characteristics of the fisheye lens will be referred to as second projection characteristics when appropriate.

(Summary of Projection Characteristics of Fisheye Lens)

According to the first projection characteristics of a fisheye lens, when the photographer is stationary and the object is moving, a motion of the object that appears in a central part of a screen is to be enlarged and projected onto the photographing surface.

In addition, according to the second projection characteristics of a fisheye lens, when the object is stationary and the photographer is moving, a motion of the object that appears in a 45-degree direction is to be enlarged and projected onto the photographing surface.

In both cases, a motion of an object that appears close to an edge is to be reduced and projected onto the photographing surface.

Let us now consider performing motion detection based on an image obtained by photography using a fisheye lens. In motion detection, processing of comparing a present frame with a previous (for example, immediately preceding) frame to detect a motion vector is performed. A motion vector refers to a value that indicates a movement direction and a movement amount of a movement by a subject on a screen. Representative methods of detecting a motion vector include a block matching method. The block matching method refers to a method involving comparing, within a set search range, a prescribed block (a rectangular block made up of m-number of pixels×n-number of pixel) in a present frame with pixels around the block at a same position in a previous frame, and obtaining a motion vector based on a result of the comparison. Although expanding the search range improves detection accuracy of a motion vector, an amount of calculation increases and a larger memory capacity becomes necessary. Therefore, preferably, the search range can be reduced without lowering detection accuracy of a motion vector.

In consideration thereof, in an embodiment of the present disclosure, the search range of a motion vector is set based on the projection characteristics of a fisheye lens described above. The first projection characteristics of a fisheye lens indicate that a motion of an object that is separated from the center is reduced and projected onto the photographing surface. According to the first projection characteristics, when a photographing side is stationary or moving at a low speed, the probability that a block corresponding to a prescribed block is searched in a vicinity of a position of the prescribed block in a previous frame increases. Therefore, the search range of a motion vector can be reduced in a peripheral part of the screen.

In addition, the second projection characteristics of a fisheye lens indicate that a motion of the object on the photographing surface is small when the object appears in front (0-degree direction) or directly horizontal (90-degree direction). According to the second projection characteristics, when a photographer is moving, in a central part and a peripheral part of the screen, the probability that a block corresponding to the prescribed block is searched in a vicinity of a position of the prescribed block in a previous frame increases. Therefore, the search range of a motion vector can be reduced in the central part and the peripheral part of the screen.

The first projection characteristics of a fisheye lens are manifested when a mobile body is stationary or moving at a low speed. In addition, the second projection characteristics of a fisheye lens are manifested when the mobile body is moving. Therefore, when a fisheye lens is applied to an in-vehicle device of a mobile body, setting the search range of a motion vector in accordance with a moving speed of the mobile body enables the search range of a motion vector to be optimized and efficiency of processing to be improved. Based on the above, an embodiment of the present disclosure will be described in detail.

### Embodiment

An embodiment will now be described. In the embodiment, an automobile will be described as an example of a mobile body. The mobile body may be any mobile body such as a train, a motorcycle, a bicycle, or the like as long as the mobile body is capable of moving in at least one direction (for example, going forward or going backward). In addition, in the embodiment, as a device to which the image processing apparatus according to the present disclosure is to be applied, an example of an in-vehicle device or, more specifically, a dashboard camera that records an image photographed during a movement of the automobile will be described as an example.

[Dashboard Camera]

(Configuration Example of Dashboard Camera)

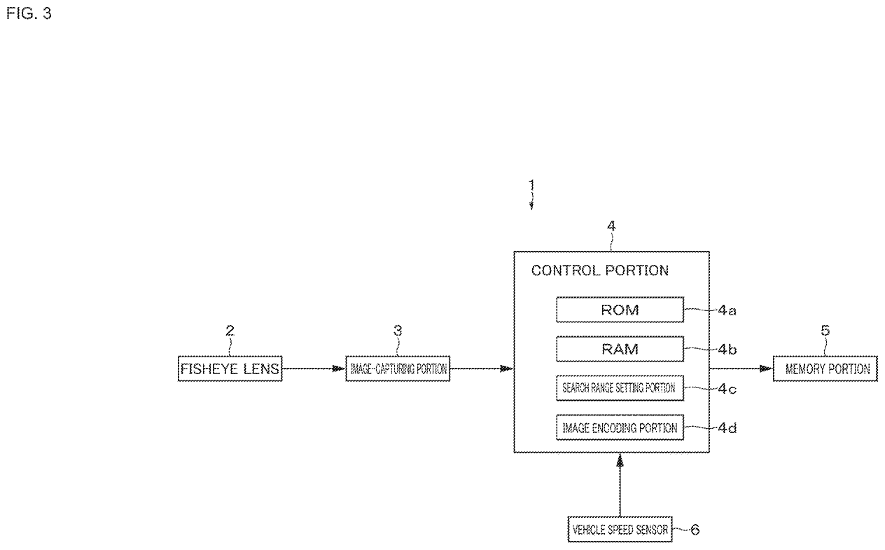

FIG. 3 is a block diagram showing a configuration example of a dashboard camera (a dashboard camera 1) according to the embodiment. For example, the dashboard camera 1 includes a fisheye lens 2, an image-capturing portion 3, a control portion 4, a memory portion 5, and a vehicle speed sensor 6.

The fisheye lens 2 is a lens capable of photographing a range with a 180-degree angle of view. The fisheye lens 2 has the first and second projection characteristics described above.

The image-capturing portion 3 is an imaging element that converts light obtained via the fisheye lens 2 into an electric signal. Examples of the image-capturing portion 3 include a CMOS (Complementary Metal Oxide Semiconductor) sensor and a CCD (Charge Coupled Device) sensor.

The control portion 4 controls respective portions of the dashboard camera 1. For example, the control portion 4 converts an image signal input from the image-capturing portion 3 into a digital signal and performs various types of image processing with respect to the digital image signal. In addition, the control portion 4 switches, in accordance with a moving speed of the mobile body, different search ranges of a motion vector set in accordance with the projection characteristics of the fisheye lens.

For example, the control portion 4 according to the present embodiment includes a ROM (Read Only Memory) 4a, a RAM (Random Access Memory) 4b, a search range setting portion 4c, and an image encoding portion 4d. The ROM 4a stores a program to be executed by the control portion 4. The RAM 4b is used as a work memory when the control portion 4 executes the program. The search range setting portion 4c sets a search range of a motion vector in accordance with a vehicle speed of the automobile and outputs search range setting information indicating the search range of a motion vector. The image encoding portion 4d encodes an image input from the image-capturing portion 3. The image encoding portion 4d according to the present embodiment encodes an image signal by a system known as H.264/AVC (Audio Video Coding). It should be noted that an encoding system is not limited to H.264/AVC and other encoding systems that detect a motion vector by a block matching method can be applied. The encoded image signal is stored in the memory portion 5 in accordance with control by the control portion 4.

The memory portion 5 is a storage portion that stores various types of information. Examples of the memory portion 5 include a magnetic storage device such as an HDD (Hard Disk Drive), a semiconductor storage device, an optical storage device, and a magneto-optical storage device. The memory portion 5 may be built into the dashboard camera 1, may be attachable to and detachable from the dashboard camera 1, or both.

The vehicle speed sensor 6 is a sensor that detects a vehicle speed that is a moving speed of the automobile. Vehicle speed information indicating the vehicle speed detected by the vehicle speed sensor 6 is input to the control portion 4.

(Configuration Example of Image Encoding Portion)

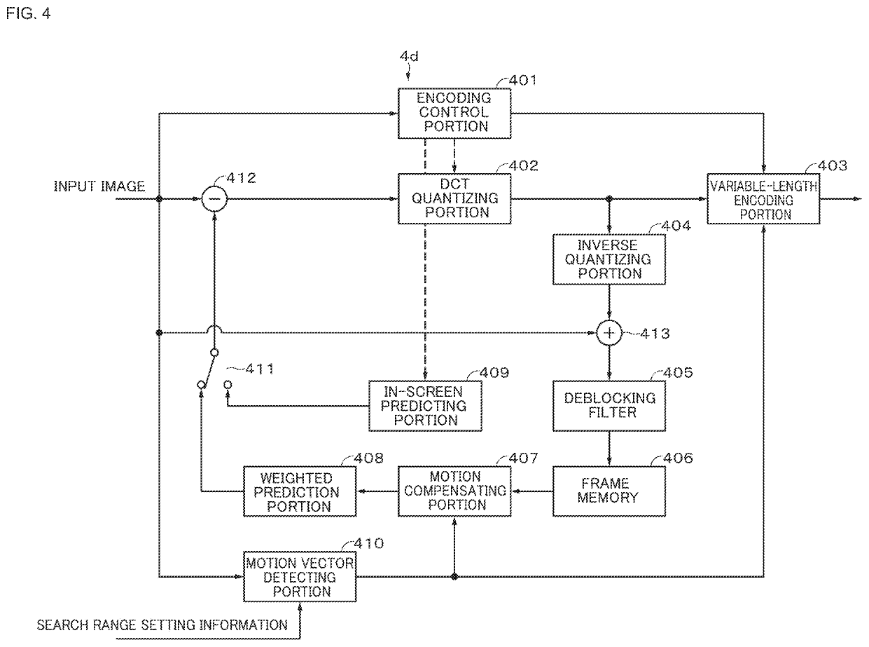

FIG. 4 is a block diagram showing a configuration example of the image encoding portion 4d. Since the encoding method according to H.264/AVC itself is well known, only a general description the configuration of the image encoding portion 4d will be given.

For example, the image encoding portion 4d includes an encoding control portion 401, a DCT (Discrete Cosine Transform) quantizing portion 402, a variable-length encoding portion 403, an inverse quantizing portion 404, a deblocking filter 405, a frame memory 406, a motion compensating portion 407, a weighted prediction portion 408, an in-screen predicting portion 409, a motion vector detecting portion 410, a switch 411, a subtracter 412, and an adder 413.

The encoding control portion 401 sets information for designating quantization specificity and the like to the DCT quantizing portion 402 and performs various types of control when encoding an image signal. The DCT quantizing portion 402 performs quantization by DCT, and the variable-length encoding portion 403 performs variable-length encoding in which a suitable sign (bit) is assigned to information quantized by the DCT quantizing portion 402. The inverse quantizing portion 404 inversely quantizes an image having been quantized by the DCT quantizing portion 402. The deblocking filter 405 is a filter that reduces block distortion that occurs when encoding an image. The frame memory 406 is a memory that temporarily accumulates a same image as an image to be reproduced on a receiving side. An image accumulated in the frame memory 406 is referred to upon compression of a next input image or the like.

The motion compensating portion 407 performs motion compensation based on the motion vector detected by the motion vector detecting portion 410. The weighted prediction portion 408 generates a predictive signal by adaptively multiplying an image signal subjected to motion compensation by a weight coefficient instead of a constant coefficient. When an intra-frame mode is being selected, the in-screen predicting portion 409 subjects a present frame to compression encoding only within the frame. The motion vector detecting portion 410 detects a motion vector using an input image. The motion vector detecting portion 410 detects a motion vector in a search range having been designated based on search range setting information supplied from the search range setting portion 4c.

The switch 411 is a switch for switching between the intra-frame mode described above and an inter-frame mode in which compression encoding is performing using a difference in motions between preceding and succeeding frames. The subtracter 412 calculates a difference between an input image and an image (a predictive image) that is supplied from the switch 411. The adder 413 adds up the input image and an output of the inverse quantizing portion 404.

(Operation Example of Dashboard Camera)

An operation example of the dashboard camera 1 will be generally described. While the automobile is moving, image processing by the control portion 4 is performed with respect to an image obtained by the fisheye lens 2 and the image-capturing portion 3. In addition, an image having been encoded by the image encoding portion 4d of the control portion 4 is stored in the memory portion 5. Accordingly, a moving image when the automobile is moving can be stored in the memory portion 5. While the moving image to be stored in the memory portion 5 will be described as a moving image obtained by photographing the front of the automobile in the present embodiment, the moving image may be obtained by photographing an arbitrary direction such as the rear of the automobile. Furthermore, in the present embodiment, photography is performed not only when the automobile is moving but also when the automobile is in use but being stationary. Photography may be performed when the automobile is stationary and not in use.

[Search Range of Motion Vector]

Next, a search range of a motion vector that is set in the present embodiment will be described. First and second search ranges can be set as the search range of a motion vector. The first search range of a motion vector is set when the vehicle speed of the automobile is a low speed (including being stationary) that is lower than a threshold. The second search range of a motion vector is set when the vehicle speed of the automobile is a high speed that is higher than the threshold.

An image obtained via the fisheye lens 2 is divided into a plurality of regions in accordance with an angle formed by the automobile and a photographic object (a visual angle as viewed from the automobile). In addition, in each of the first and second search ranges, a search range of a motion vector is set for each region.

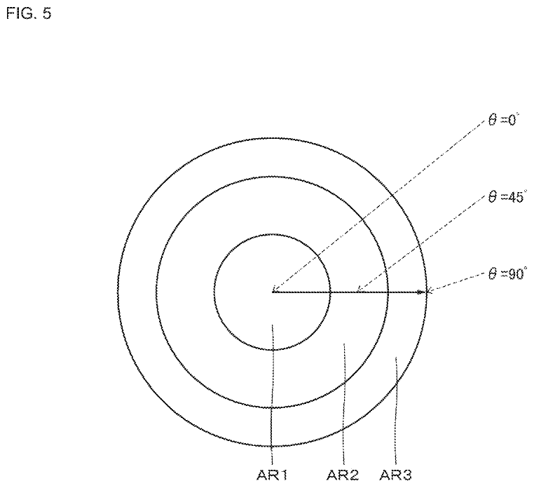

A circular fisheye image obtained via the fisheye lens 2 is projected in a circular shape on a photographing surface. For example, as shown in FIG. 5, the circular fisheye image is divided into three regions, namely, a central part AR1, an intermediate part AR2, and a peripheral part AR3. The central part AR1 includes an image region in which the angle formed by the automobile and the object is 0 degrees or, in other words, an image region near the front of the automobile. The intermediate part AR2 includes an image region in which the angle formed by the automobile and the object is 45 degrees. The peripheral part AR3 includes an image region in which the angle formed by the automobile and the object is 90 degrees or, in other words, an image region close to right beside the automobile. Since a projection position on the imaging element of the image-capturing portion 3 which corresponds to each angle is determined in advance, each region can be suitably set. Alternatively, each region may be set using other known methods.

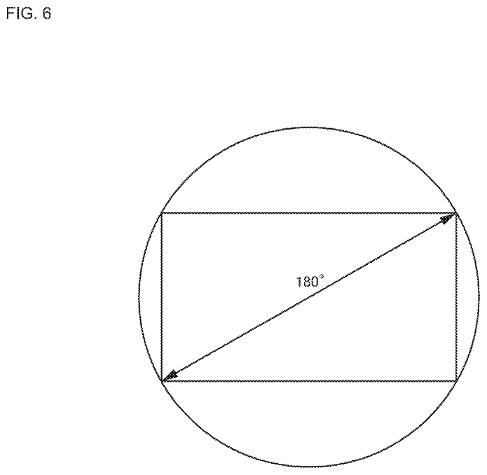

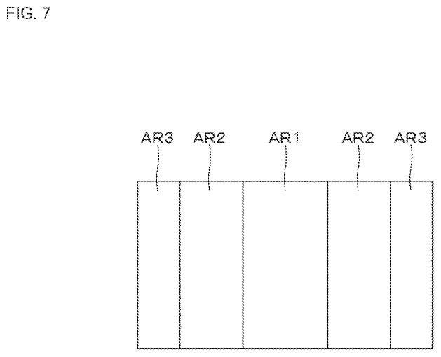

In systems using a fisheye lens, a diagonal fisheye image is more often used than a circular fisheye image. As shown in FIG. 6, a diagonal fisheye image is a rectangular image to be inscribed in a circular fisheye image and has an angle of view of 180 degrees in a diagonal direction. Since an obtained image is rectangular and an entire region of the imaging element of the image-capturing portion 3 can be used, image processing in subsequent stages can be more readily performed. As shown in FIG. 7, even in the case of a diagonal fisheye image, the image can be divided into three regions, namely, the central part AR1, the intermediate part AR2, and the peripheral part AR3. In this case, the central part AR1, the intermediate part AR2, and the peripheral part AR3 can be divided into rectangles in a simplified manner solely based on a horizontal coordinate of each pixel.

Sizes in which the central part AR1, the intermediate part AR2, and the peripheral part AR3 are to be divided can be set as appropriate. For example, the sizes may be set such that the respective image regions have approximately equivalent areas. In addition, a range of an angle formed by the automobile and the object may be set to each region.

(First Search Range of Motion Vector)

First, the first search range of a motion vector will be described. The first search range is a search range that is set in correspondence with the first projection characteristics of the fisheye lens 2. As described earlier, according to the first projection characteristics of a fisheye lens, when an object is separated from the center, a motion of the object on the photographing surface appears smaller. In other words, even when a movement distance is the same, since a movement distance of an object separated from the center is reflected shorter on the photographing surface, it is highly likely that a block corresponding to a prescribed block will be found right away between frames even when a small search range of a motion vector is set. Therefore, as the first search range, the search range of a motion vector in the peripheral part AR3 is set so as to be smaller than the search range of a motion vector in the central part AR1 and the intermediate part AR2.

(Second Search Range of Motion Vector)

First, a second search range of a motion vector will be described. The second search range is a search range that is set in correspondence with the second projection characteristics of the fisheye lens 2. According to the second projection characteristics of a fisheye lens, when the object as viewed from the automobile appears in front (0-degree direction) or immediately horizontal (90-degree direction), since a motion of the object on the photographing surface is reflected smaller, it is highly likely that a block corresponding to a prescribed block will be found right away between frames even when a small search range of a motion vector is set. Therefore, as the second search range, the search range of a motion vector in the central part AR1 and the peripheral part AR3 is set so as to be smaller than the search range of a motion vector in the intermediate part AR2.

[Threshold Set with Respect to Vehicle Speed]

As described above, the first search range of a motion vector is set when the vehicle speed of the automobile is a low speed (the automobile may also be stationary) that is lower than a threshold. In addition, the second search range of a motion vector is set when the vehicle speed of the automobile is a high speed that is higher than the threshold. An example of the threshold that is set with respect to the vehicle speed of the automobile will now be described.

As an example, an object that appears near 30-degrees horizontal which is considered an effective field of view of a human being will be assumed. This equates to 15-degrees left and right as an angle from a front view. Although the term “effective field of view” has several definitions, in the present example, an effective field of view refers to a range in which visual information is obtained in a state of gazing at one point to the front without turning one's head.

θ=15 degrees is assigned to each of mathematical expression 2 described above that indicates a movement distance of the object and mathematical expression 5 described above that indicates a movement distance of a photographing side (in the present embodiment, the automobile). As a result of the respective calculations, it is revealed that there is a difference of a factor or approximately 3.7 between effects on an amount of motion (displacement) d0 that appears on the photographing surface.

Assuming that the object is a pedestrian and the moving speed is 4 km/h (for example, a moving speed in an urban area is assumed), a dominant effect can be exerted on the amount of motion when one's own speed is higher than 15 km/h. Therefore, under this assumption, a threshold with respect to vehicle speed is set to around 15 km/h. The threshold in this case means that a threshold by which motion detection should be searched wider in an outer region (45-degree direction) rather than within the effective field of view is 15 km/h.

[Flow of Processing]

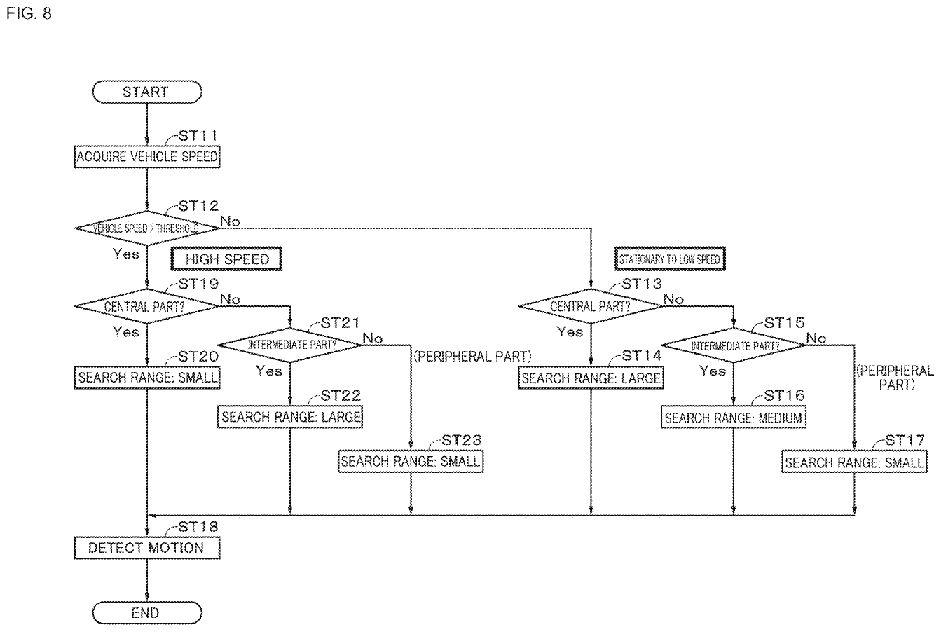

Next, a flow of processing performed by the dashboard camera 1 according to the embodiment will be described with reference to the flow chart shown in FIG. 8. For example, the processing described below is to be performed by the control portion 4 unless otherwise noted.

After processing starts, in step ST11, the vehicle speed sensor 6 acquires a vehicle speed of an automobile. Vehicle speed information indicating the vehicle speed of the automobile is supplied to the control portion 4 from the vehicle speed sensor 6. For example, the vehicle speed information is input to the control portion 4 at prescribed intervals. Subsequently, the processing advances to step ST12.

In step ST12, the control portion 4 compares the vehicle speed information with the threshold and determines whether or not the vehicle speed indicated by the vehicle speed information is higher than the threshold. At this point, for example, when the vehicle speed is equal to or lower than the threshold, the processing advances to step ST13. In the case described below, since the vehicle speed of the automobile is stationary or a low speed, the first search range is set as the search range of a motion vector.

In step ST13, a determination is made as to whether or not a prescribed block in a present frame is present in the central part AR1. When the prescribed block straddles the central part AR1 and the intermediate part AR2 or the like, a region with a larger overlap may be determined to be the region in which the block is present. When the prescribed block is present in the central part AR1, the processing advances to step ST14.

In step ST14, the search range setting portion 4c of the control portion 4 sets a search range in which a block corresponding to the prescribed block is to be searched in (a previous frame) to “large” and outputs the set search range as search range setting information to the motion vector detecting portion 410. Subsequently, the processing advances to step ST18.

In step ST18, the motion vector detecting portion 410 performs block matching in a search range based on the search range setting information and detects a motion vector based on a result of the block matching. In addition, encoding processing using the detected motion vector is performed by the image encoding portion 4d. Although not illustrated, compression-encoded video is stored in the memory portion 5.

In the processing of step ST13, when the prescribed block is not present in the central part AR1, the processing advances to step ST15. In step ST15, a determination is made as to whether or not the prescribed block is present in the intermediate part AR2. When the prescribed block is present in the intermediate part AR2, the processing advances to step ST16.

The intermediate part AR2 is a region positioned on a peripheral side of the central part AR1. Therefore, in step ST16, the search range setting portion 4c of the control portion 4 sets the search range in which a block corresponding to the prescribed block is to be searched in the previous frame to “medium” that is smaller than the search range that is set in step ST14 and outputs the set search range as search range setting information to the motion vector detecting portion 410. Subsequently, the processing advances to step ST18. The processing performed in step ST18 is as described above.

In the processing of step ST15, when the prescribed block is not present in the intermediate part AR2, this means that the prescribed block is present in the peripheral part AR3. Subsequently, the processing advances to step ST17.

In step ST17, the search range setting portion 4c of the control portion 4 sets the search range in which a block corresponding to the prescribed block is to be searched in the previous frame to “small” that is smaller than the search ranges that are set in steps ST14 and ST16 and outputs the set search range as search range setting information to the motion vector detecting portion 410. Subsequently, the processing advances to step ST18. The processing performed in step ST18 is as described above. In this manner, when the vehicle speed is stationary or a low speed, the search range of a motion vector is set such that the closer the position of the prescribed block is to a periphery than a center of an image, the smaller the search range.

On the other hand, in the processing of step ST12, when the vehicle speed indicated by the vehicle speed information is higher than the threshold, the processing advances to step ST19. In the case described below, since the vehicle speed of the automobile is a high speed that is equal to or higher than a certain speed, the second search range is set as the search range of a motion vector.

In step ST19, a determination is made as to whether or not a prescribed block in the present frame is present in the central part AR1. When the prescribed block is present in the central part AR1, the processing advances to step ST20.

In step ST20, the search range setting portion 4c of the control portion 4 sets a search range in which a block corresponding to the prescribed block is to be searched in a previous frame to “small” and outputs the set search range as search range setting information to the motion vector detecting portion 410. The “small” search range of a motion vector may be a same size as the search range of a motion vector set in step ST17 described above or may be a different size. Subsequently, the processing advances to step ST18. Since the processing of step ST18 has already been described above, a redundant description will be omitted.

In the processing of step ST19, when the prescribed block is not present in the central part AR1, the processing advances to step ST21. In step ST21, a determination is made as to whether or not the prescribed block is present in the intermediate part AR2. When the prescribed block is present in the intermediate part AR2, the processing advances to step ST22.

In the second search range of a motion vector, the search range of the intermediate part AR2 is increased. Therefore, in step ST20, the search range setting portion 4c of the control portion 4 sets the search range in which a block corresponding to the prescribed block is to be searched in the previous frame to “large” that is larger than the search range that is set in step ST20 and outputs the set search range as search range setting information to the motion vector detecting portion 410. The “large” search range of a motion vector may be a same size as the search range of a motion vector set in step ST14 described above or may be a different size. Subsequently, the processing advances to step ST18. Since the processing of step ST18 has already been described above, a redundant description will be omitted.

In the processing of step ST21, when the prescribed block is not present in the intermediate part AR2, this means that the prescribed block is present in the peripheral part AR3. Subsequently, the processing advances to step ST23.

In step ST23, the search range setting portion 4c of the control portion 4 sets the search range in which a block corresponding to the prescribed block is to be searched in the previous frame to “small” that is smaller than the search range that is set in step ST22 and outputs the set search range as search range setting information to the motion vector detecting portion 410. The “small” search range of a motion vector may be a same size as the search ranges of a motion vector set in steps ST17 and ST20 described above or may be a different size. Subsequently, the processing advances to step ST18. Since the processing of step ST18 has already been described above, a redundant description will be omitted.

In the description provided above, a description of search ranges having been divided into “large”, “medium”, and “small” has been given for the sake of brevity. Actual sizes of search ranges are suitably set in consideration of a capacity of the frame memory 406, access performance of the control portion 4 with respect to the frame memory 406, an allowable range of a memory bus, or the like.

[Effects Produced by Embodiment]

In the embodiment described above, for example, the following effects are produced. Performing processing in consideration of projection characteristics of a fisheye lens enables a search range of a motion vector to be optimized in accordance with a vehicle speed of a mobile body. More specifically, when the vehicle speed is low, a motion vector can be accurately obtained by widely and finely searching a central part of a screen where a motion of an object is readily reflected. In addition, when the vehicle speed is low, by limiting the search range of a motion vector with respect to a peripheral part of the screen where a motion of the object is compressed, effects such as a reduction in processing time, a reduction in memory access bands, and a reduction in power consumption are produced.

On the other hand, when the vehicle speed is high, widely searching a peripheral part of a 45-degree angle where a motion vector due to a motion of an automobile appears enlarged enables a motion vector to be detected in an efficient manner. In addition, when the vehicle speed is high, by limiting the search range of a motion vector with respect to the central part and the peripheral part of the screen where an amount of motion appears relatively small, effects such as a reduction in processing time, a reduction in memory access bands, and a reduction in power consumption are produced. In this manner, by adaptively switching among search ranges of a motion vector in accordance with vehicle speeds, effects such as a reduction in processing time, a reduction in memory access bands, and a reduction in power consumption are produced.

<Modifications>

While a plurality of embodiments of the present disclosure have been described with specificity above, it is to be understood that the contents of the present disclosure are not limited to the embodiments described above and that various modifications can be made based on the technical ideas of the present disclosure. Hereinafter, modifications will be described.

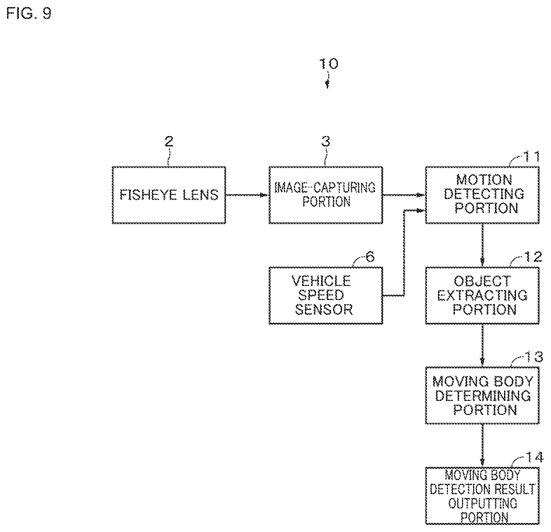

The present disclosure can also be applied to apparatuses other than a dashboard camera. FIG. 9 is a block diagram showing, when the present disclosure is applied to a moving body detection apparatus (a moving body detection apparatus 10), a configuration example of the moving body detection apparatus 10. In the moving body detection apparatus 10, components that are the same or homogeneous to those included in the dashboard camera 1 are assigned same reference signs.

The moving body detection apparatus 10 includes the fisheye lens 2, the image-capturing portion 3, the vehicle speed sensor 6, a motion detecting portion 11, an object extracting portion 12, a moving body determining portion 13, and a moving body detection result outputting portion 14. Since the fisheye lens 2, the image-capturing portion 3, and the vehicle speed sensor 6 have already been described in the embodiment, redundant descriptions will be omitted.

The motion detecting portion 11 detects a motion vector. A detection result of a motion vector is supplied to the object extracting portion 12. Based on the motion vector detection result, the object extracting portion 12 extracts a region that moves in a same direction as a moving body (for example, a pedestrian or a bicycle). The moving body determining portion 13 determines a motion of the object (the moving body) extracted by the object extracting portion 12. The moving body detection result outputting portion 14 outputs a detection result of the moving body by display or the like.

For example, the detection result of the moving body is fed back to a driver of the mobile body and conveyed as danger prediction or a warning. The detection result of the moving body may also be used by an automatic driving apparatus to recognize surrounding circumstances.

When the motion detecting portion 11 detects a motion vector, the present disclosure can be applied in a similar manner to the embodiment. Specifically, by inputting vehicle speed information from the vehicle speed sensor 6 to the motion detecting portion 11, a search range when the motion detecting portion 11 detects a motion vector can be optimized. Accordingly, effects similar to those of the embodiment can be produced.

Other modifications will now be described. While the embodiment presented above has been described using equidistant projection as an example, the present disclosure can also be applied to fisheye lenses having other projection characteristics (for example, an equisolid angle projection system or an orthographic projection system). In addition, the present disclosure can also be applied to optical systems (for example, an ultrawide-angle lens) having special projection characteristics that achieve both linearity of a central part and a wide angle of view by reducing distortion in a wide range at a center of a screen and increasing distortion in a peripheral part of the screen.

While a configuration which uses a vehicle speed sensor to obtain a moving speed of a mobile body has been described in the embodiment presented above, the configuration is not restrictive. For example, the moving speed of a mobile body may be obtained using an image obtained via a fisheye lens. Known methods of obtaining the moving speed of a mobile body from an image can be applied. As an example, the moving speed of a mobile body can be obtained based on a repetitive period of a divided center line. In order to further improve detection accuracy of the moving speed of a mobile body, the moving speed of a mobile body may be obtained using both a vehicle speed sensor and an image obtained via a fisheye lens.

The present disclosure can also be realized by an apparatus, a method, a program, a system, or the like. For example, by making a program that performs the functions described in the embodiment presented above downloadable and having an apparatus that does not include the functions described in the embodiment download and install the program, the controls described in the embodiment can be performed in the apparatus. The present disclosure can also be realized by a server that distributes such a program. In addition, matters described in the respective embodiments and modifications can be combined to the extent feasible.

The present disclosure can also adopt the following configurations.

(1)

An image processing apparatus, including:

a control portion configured to switch, in accordance with a moving speed of a mobile body, different search ranges of a motion vector set in accordance with projection characteristics of a fisheye lens.

(2)

The image processing apparatus according to (1), wherein

an image obtained via the fisheye lens is divided into a plurality of regions in accordance with an angle formed by the mobile body and an object, and the search range of a motion vector is set for each of the regions.

(3)

The image processing apparatus according to (2), wherein

the image is divided into a central part, an intermediate part, and a peripheral part in accordance with an angle formed by the mobile body and the object.

(4)

The image processing apparatus according to (3), wherein

a first search range and a second search range are set as the search range of a motion vector,

as the first search range, a search range of a motion vector in the peripheral part is set so as to be smaller than a search range of a motion vector in the central part and the intermediate part, and

as the second search range, a search range of a motion vector in the central part and the peripheral part is set so as to be smaller than a search range of a motion vector in the intermediate part.

(5)

The image processing apparatus according to (4), wherein

the control portion is configured to

set the first search range as the search range of a motion vector when a moving speed of the mobile body is a low speed that is lower than a prescribed threshold, and

set the second search range as the search range of a motion vector when the moving speed of the mobile body is a high speed that is higher than the prescribed threshold.

(6)

The image processing apparatus according to any one of (3) to (5), wherein

the central part includes an image region where an angle formed by the mobile body and the object is 0 degrees,

the intermediate part includes an image region where an angle formed by the mobile body and the object is 45 degrees, and

the peripheral part includes an image region where an angle formed by the mobile body and the object is 90 degrees.

(7)

The image processing apparatus according to any one of (3) to (6), wherein the image is a rectangular image.

(8)

The image processing apparatus according to any one of (1) to (7), wherein

a moving speed of the mobile body is detected using at least one of a vehicle speed sensor and an image obtained via the fisheye lens.

(9)

An in-vehicle device, including:

a fisheye lens;

an image-capturing portion; and

a control portion configured to set a search range for detecting a motion vector based on an image obtained by the fisheye lens and the image-capturing portion, wherein

the control portion is configured to switch, in accordance with a moving speed of a mobile body, different search ranges of a motion vector set in accordance with projection characteristics of the fisheye lens.

(10)

An image processing method, including:

a control portion switching, in accordance with a moving speed of a mobile body, different search ranges of a motion vector set in accordance with projection characteristics of a fisheye lens.

(11)

A program that causes a computer to execute an image processing method including:

a control portion switching, in accordance with a moving speed of a mobile body, different search ranges of a motion vector set in accordance with projection characteristics of a fisheye lens.

<Applications>

The technique according to the present disclosure can be applied to various products. For example, the technique according to the present disclosure may be realized as an apparatus to be mounted to any of various types of mobile bodies including an automobile, an electric vehicle, a hybrid electric vehicle, a motorcycle, a bicycle, personal mobility, an airplane, a drone, an ocean vessel, a robot, construction machinery, and agricultural and farm machinery (a tractor).

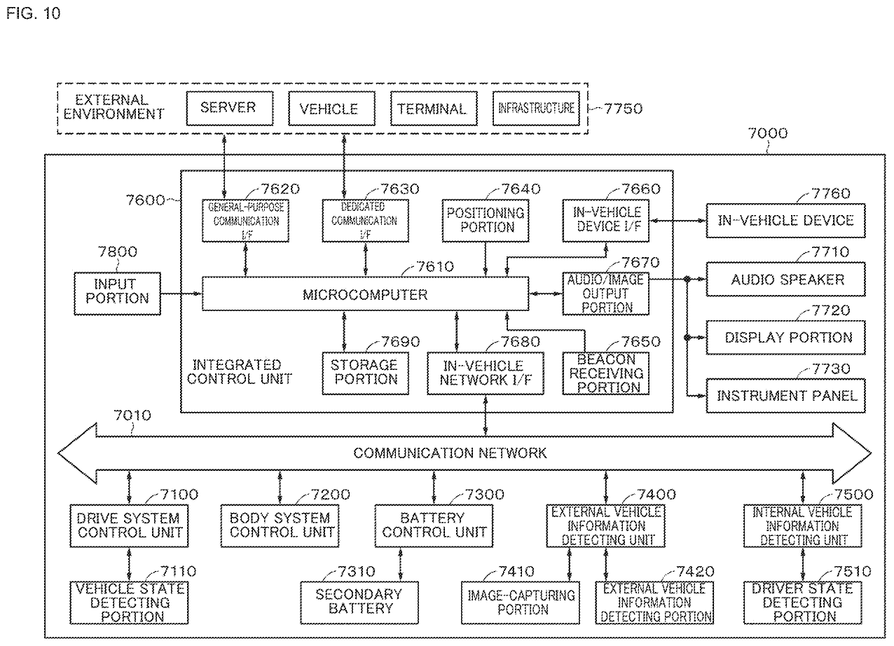

FIG. 10 is a block diagram showing a schematic configuration example of a vehicle control system 7000 that represents an example of a mobile body control system to which the technique according to the present disclosure may be applied. The vehicle control system 7000 includes a plurality of electronic control units that are connected via a communication network 7010. In the example shown in FIG. 10, the vehicle control system 7000 includes a drive system control unit 7100, a body system control unit 7200, a battery control unit 7300, an external vehicle information detecting unit 7400, an internal vehicle information detecting unit 7500, and an integrated control unit 7600. The communication network 7010 that connects the plurality of control units may be a vehicle-mounted communication network compliant with an arbitrary standard such as a CAN (Controller Area Network), a LIN (Local Interconnect Network), a LAN (Local Area Network), or FlexRay (registered trademark).

Each control unit includes a microcomputer that performs arithmetic processing in accordance with various programs, a storage portion that stores programs to be executed by the microcomputer, parameters to be used in various calculations, and the like, and a drive circuit that drives various apparatuses which are control targets. Each control unit includes a network I/F for communicating with other control units via the communication network 7010 and a communication I/F for communicating with apparatuses, sensors, and the like inside and outside the vehicle by wired communication or wireless communication. FIG. 10 illustrates, as functional components of the integrated control unit 7600, a microcomputer 7610, a general-purpose communication I/F 7620, a dedicated communication I/F 7630, a positioning portion 7640, a beacon receiving portion 7650, an on-board device I/F 7660, an audio/video output portion 7670, a vehicle-mounted network I/F 7680, and a storage portion 7690. The other control units similarly include a microcomputer, a communication I/F, a storage portion, and the like.

The drive system control unit 7100 controls operations of apparatuses related to a drive system of a vehicle in accordance with various programs. For example, the drive system control unit 7100 functions as a control apparatus of a drive force generation apparatus for generating a drive force of the vehicle such as an internal engine or a drive motor, a control apparatus of a drive force transmission mechanism for transmitting the drive force to wheels, a control apparatus of a steering mechanism for adjusting a steering angle of the vehicle, and a control apparatus of a braking apparatus that generates a brake force of the vehicle. The drive system control unit 7100 may have functions as a control apparatus of an ABS (Antilock Brake System), a control apparatus of ESC (Electronic Stability Control), or the like.

A vehicle state detecting portion 7110 is connected to the drive system control unit 7100. For example, the vehicle state detecting portion 7110 includes at least one of a gyroscope sensor that detects an angular velocity of a rotational motion of a shaft of a vehicle body, an acceleration sensor that detects an acceleration of the vehicle, and a sensor for detecting an operation amount of a gas pedal, an operation amount of a brake pedal, a steering angle of a steering wheel, the number of revolutions of an engine, a rotational speed of a wheel, or the like. The drive system control unit 7100 performs arithmetic processing using a signal input from the vehicle state detecting portion 7110 and controls an internal engine, a drive motor, an electric power steering apparatus, a brake apparatus, or the like.

The body system control unit 7200 controls operations of various apparatuses mounted to a vehicle body in accordance with various programs. For example, the body system control unit 7200 functions as a control apparatus of a key-less entry system, a smart key system, a power window apparatus, or various lamps such as head lamps, tail lamps, brake lamps, turn indicators, and fog lamps. In this case, radio waves or signals of various switches which are transmitted from a portable device that substitutes as a key may be input to the body system control unit 7200. The body system control unit 7200 accepts input of the radio waves or signals and controls a door lock apparatus, the power window apparatus, the lamps, and the like of the vehicle.

The battery control unit 7300 controls a secondary battery 7310 that is a power supply source of the drive motor in accordance with various programs. For example, information on a battery temperature, a battery output voltage, a battery remaining capacity, or the like is input to the battery control unit 7300 from a battery apparatus including the secondary battery 7310. The battery control unit 7300 uses these signals to perform arithmetic processing to control temperature regulation of the secondary battery 7310 or to control a cooling apparatus or the like included in the battery apparatus.

The external vehicle information detecting unit 7400 detects information on an exterior of the vehicle that is mounted with the vehicle control system 7000. For example, at least one of an image-capturing portion 7410 and an external vehicle information detecting portion 7420 is connected to the external vehicle information detecting unit 7400. The image-capturing portion 7410 includes at least one of a ToF (Time of Flight) camera, a stereo camera, a monocular camera, an infrared camera, and other cameras. For example, the external vehicle information detecting portion 7420 includes at least one of an environmental sensor for detecting present weather or meteorological phenomena and an ambient information detection sensor for detecting other vehicles, obstacles, pedestrians, or the like around the vehicle mounted with the vehicle control system 7000.

For example, the environmental sensor may be at least one of a raindrop sensor that detects rainy weather, a fog sensor that detects fog, a sunshine sensor that detects a degree of sunshine, and a snow sensor that detects snowfall. The ambient information detection sensor may be at least one of an ultrasonic sensor, a radar apparatus, and a LIDAR (Light Detection and Ranging, Laser Imaging Detection and Ranging) apparatus. The image-capturing portion 7410 and the external vehicle information detecting portion 7420 may be respectively included as an independent sensor or an independent apparatus or may be included as an apparatus that integrates a plurality of sensors or apparatuses.

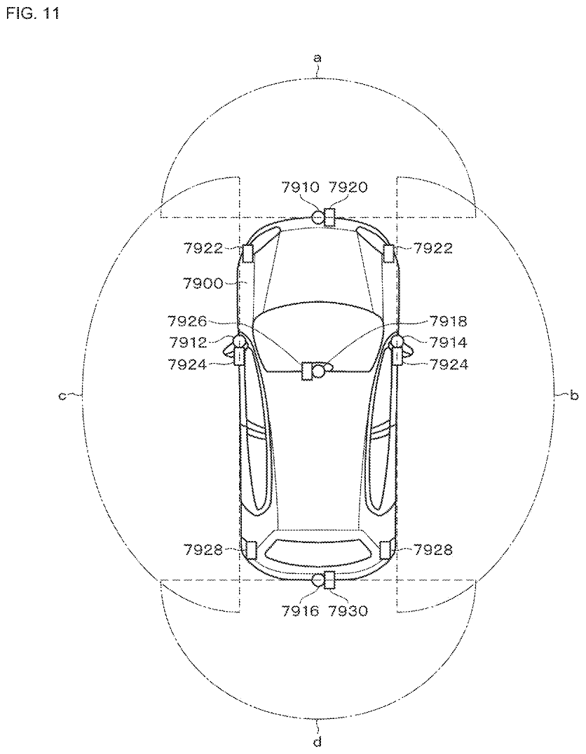

FIG. 11 is a diagram showing an example of installation positions of the image-capturing portion 7410 and the external vehicle information detecting portion 7420. For example, image-capturing portions 7910, 7912, 7914, 7916, and 7918 are provided at least one position among a front nose, side mirrors, a rear bumper, a rear door, and an upper part of a front glass inside a cabin of a vehicle 7900. The image-capturing portion 7910 that is provided on the front nose and the image-capturing portion 7918 that is provided in the upper part of the front glass inside the cabin mainly acquire an image of the front of the vehicle 7900. The image-capturing portions 7912 and 7914 that are provided on the side mirrors mainly acquire an image of the sides of the vehicle 7900. The image-capturing portion 7916 that is provided on the rear bumper or the rear door mainly acquires an image of the rear of the vehicle 7900. The image-capturing portion 7918 that is provided in the upper part of the front glass inside the cabin is mainly used to detect vehicles ahead, pedestrians, obstacles, traffic lights, traffic signs, lanes, and the like.

FIG. 11 shows an example of photographic ranges of the respective image-capturing portions 7910, 7912, 7914, and 7916. An image-capturing range a represents an image-capturing range of the image-capturing portion 7910 that is provided on the front nose, image-capturing ranges b and c respectively represent image-capturing ranges of the image-capturing portions 7912 and 7914 that are provided on the side mirrors, and an image-capturing range d represents an image-capturing range of the image-capturing portion 7916 that is provided on the rear bumper or the rear door. For example, by superimposing image data captured by the image-capturing portions 7910, 7912, 7914, and 7916, a bird's-eye view image of the vehicle 7900 as viewed from above is obtained.

For example, external vehicle information detecting portions 7920, 7922, 7924, 7926, 7928, and 7930 provided in the front, the rear, the sides, a corner, and the upper part of the front glass inside the cabin of the vehicle 7900 may be ultrasonic sensors or radar apparatuses. For example, the external vehicle information detecting portions 7920, 7926, and 7930 provided on the front nose, the rear bumper, the rear door, and the upper part of the front glass inside the cabin of the vehicle 7900 may be LIDAR apparatuses. The external vehicle information detecting portions 7920 to 7930 are mainly used to detect vehicles ahead, pedestrians, obstacles, and the like.

Let us return to FIG. 10 to continue with the description. The external vehicle information detecting unit 7400 causes the image-capturing portion 7410 to capture an image of the exterior of the vehicle and receives captured image data. In addition, the external vehicle information detecting unit 7400 receives detection information from the external vehicle information detecting portion 7420 being connected thereto. When the external vehicle information detecting portion 7420 is an ultrasonic sensor, a radar apparatus, or a LIDAR apparatus, the external vehicle information detecting unit 7400 causes the external vehicle information detecting portion 7420 to transmit ultrasonic waves, electromagnetic waves, or the like and receives information on received reflected waves. Based on the received information, the external vehicle information detecting unit 7400 may perform object detection processing or distance detection processing with respect to people, vehicles, obstacles, signs, characters on road surfaces, and the like. Based on the received information, the external vehicle information detecting unit 7400 may perform environmental recognition processing for recognizing rainfall, fog, road surface conditions, or the like. Based on the received information, the external vehicle information detecting unit 7400 may calculate a distance to an object outside of the vehicle.

In addition, based on received image data, the external vehicle information detecting unit 7400 may perform image recognition processing or distance detection processing for recognizing people, vehicles, obstacles, signs, characters on road surfaces, and the like. The external vehicle information detecting unit 7400 may perform processing such as distortion correction or positioning with respect to the received image data and composite the image data captured by different image-capturing portions 7410 to generate a bird's-eye view image or a panoramic image. The external vehicle information detecting unit 7400 may perform viewpoint transformation processing using image data captured by different image-capturing portions 7410.

The internal vehicle information detecting unit 7500 detects information on an interior of the vehicle. For example, a driver state detecting portion 7510 that detects a state of a driver is connected to the internal vehicle information detecting unit 7500. The driver state detecting portion 7510 may include a camera that captures an image of the driver, a biometric sensor that detects biological information of the driver, a microphone that collects sound inside the cabin, or the like. For example, the biometric sensor is provided on a seat surface, the steering wheel, or the like, and detects biological information of a passenger sitting on the seat or the driver holding the steering wheel. Based on detection information input from the driver state detecting portion 7510, the internal vehicle information detecting unit 7500 may calculate a degree of fatigue or a degree of concentration of the driver or may determine whether or not the driver has fallen asleep. The internal vehicle information detecting unit 7500 may perform processing such as noise cancellation processing with respect to a collected sound signal.

The integrated control unit 7600 controls overall operations in the vehicle control system 7000 in accordance with various programs. An input portion 7800 is connected to the integrated control unit 7600. The input portion 7800 is realized by an apparatus on which a passenger can perform input operations such as a touch panel, a button, a microphone, a switch, a lever, or the like. Data obtained by subjecting sound input from the microphone to speech recognition may be input to the integrated control unit 7600. For example, the input portion 7800 may be a remote-controlled apparatus using infrared light or other radio waves or an externally-connected device such as a mobile phone or a PDA (Personal Digital Assistant) that accommodates operations of the vehicle control system 7000. For example, the input portion 7800 may be a camera, in which case a passenger can input information by gesturing to the camera. Alternatively, data obtained by detecting a motion of a wearable apparatus being worn by a passenger may be input. Furthermore, for example, the input portion 7800 described above may include an input control circuit or the like which generates an input signal based on information input by a passenger or the like using the input portion 7800 and which outputs the generated input signal to the integrated control unit 7600. By operating the input portion 7800, a passenger or the like inputs various types of data and issues instructions to perform processing operations with respect to the vehicle control system 7000.

The storage portion 7690 may include a ROM (Read Only Memory) that stores various programs to be executed by the microcomputer and a RAM (Random Access Memory) that stores various parameters, calculation results, sensor values, or the like. In addition, the storage portion 7690 may be realized by a magnetic storage device such as an HDD (Hard Disc Drive), a semiconductor storage device, an optical storage device, a magneto-optical storage device, or the like.

The general-purpose communication I/F 7620 is a general-purpose communication I/F that mediates communication with various devices that are present in an external environment 7750. The general-purpose communication I/F 7620 may implement a cellular communication protocol such as GSM (registered trademark) (Global System of Mobile communications), WiMAX (registered trademark), LTE (registered trademark) (Long Term Evolution), or LTE-A (LTE-Advanced) or another wireless communication protocol such as wireless LAN (also referred to as Wi-Fi (registered trademark)) or Bluetooth (registered trademark). For example, the general-purpose communication I/F 7620 may connect to a device (for example, an application server or a control server) present on an external network (for example, the Internet, a cloud network, or a company-specific network) via a base station or an access point. In addition, for example, the general-purpose communication I/F 7620 may connect to a terminal (for example, a terminal belonging to the driver or a pedestrian, a terminal of a store, or an MTC (Machine Type Communication) terminal) that is present in a vicinity of the vehicle using P2P (Peer To Peer) technology.

The dedicated communication I/F 7630 is a communication I/F that supports a communication protocol designed to be used in a vehicle. For example, the dedicated communication I/F 7630 may implement a standard protocol such as WAVE (Wireless Access in Vehicle Environment) that is a combination of IEEE 802.11p constituting a lower layer and IEEE 1609 constituting a higher layer, DSRC (Dedicated Short Range Communications), or a cellular communication protocol. Typically, the dedicated communication I/F 7630 carries out V2X communication that is a concept including one or more of communication between vehicles (Vehicle to Vehicle communication), communication between a road and a vehicle (Vehicle to Infrastructure communication), communication between a vehicle and a home (Vehicle to Home communication), and communication between a pedestrian and a vehicle (Vehicle to Pedestrian communication).

For example, the positioning portion 7640 receives a GNSS (Global Navigation Satellite System) signal from a GNSS satellite (for example, a GPS (Global Positioning System) signal from a GPS satellite) and executes positioning, and generates positional information including a latitude, a longitude, and an elevation of the vehicle. Alternatively, the positioning portion 7640 may specify a current position by exchanging signals with a wireless access point or acquire positional information from a terminal such as a mobile phone, a PHS, or a smartphone with a positioning function.

For example, the beacon receiving portion 7650 receives radio waves or electromagnetic waves emitted from a radio station or the like installed on a road and acquires information such as a current position, congestions, closures, and required time. Alternatively, the function of the beacon receiving portion 7650 may be included in the dedicated communication I/F 7630 described above.

The on-board device I/F 7660 is a communication interface that mediates communication between the microcomputer 7610 and various on-board devices 7760 that are present inside the vehicle. The on-board device I/F 7660 may establish a wireless connection using a wireless communication protocol such as a wireless LAN, Bluetooth (registered trademark), NFC (Near Field Communication), or WUSB (Wireless USB). In addition, the on-board device I/F 7660 may establish, via a connection terminal (not illustrated) (and a cable when necessary), a wireless connection such as USB (Universal Serial Bus), HDMI (registered trademark) (High-Definition Multimedia Interface), or MHL (Mobile High-definition Link). For example, the on-board devices 7760 may include at least one of a mobile device or a wearable device that is held or worn by a passenger and an information device to be carried onto or attached to the vehicle. Furthermore, the on-board devices 7760 may include a navigation device that searches a route to an arbitrary destination. The on-board device I/F 7660 exchanges control signals and data signals with the on-board devices 7760.

The vehicle-mounted network I/F 7680 is an interface that mediates communication between the microcomputer 7610 and the communication network 7010. The vehicle-mounted network I/F 7680 transmits and receives signals and the like in accordance with a prescribed protocol that is supported by the communication network 7010.

The microcomputer 7610 of the integrated control unit 7600 controls the vehicle control system 7000 in accordance with various programs based on information acquired via at least one of the general-purpose communication I/F 7620, the dedicated communication I/F 7630, the positioning portion 7640, the beacon receiving portion 7650, the on-board device I/F 7660, and the vehicle-mounted network I/F 7680. For example, based on acquired information on the exterior and the interior of the vehicle, the microcomputer 7610 may calculate a control target value of the drive force generation apparatus, the steering mechanism, or the brake apparatus and output a control command to the drive system control unit 7100. For example, the microcomputer 7610 may perform cooperative control for the purpose of realizing functions of an ADAS (Advanced Driver Assistance System) including collision avoidance or crash mitigation of the vehicle, headway control based on inter-vehicular distance, cruise control, a collision warning of the vehicle, and a lane departure warning of the vehicle. In addition, by controlling the drive force generation apparatus, the steering mechanism, the brake apparatus, or the like based on acquired information on a periphery of the vehicle, the microcomputer 7610 may perform cooperative control for the purpose of automated driving or the like that enables the vehicle to travel autonomously without having to rely on operations by the driver.

The microcomputer 7610 may generate three-dimensional distance information between the vehicle and a surrounding object such as a structure or a person and create local map information including peripheral information of a current position of the vehicle based on information acquired via at least one of the general-purpose communication I/F 7620, the dedicated communication I/F 7630, the positioning portion 7640, the beacon receiving portion 7650, the on-board device I/F 7660, and the vehicle-mounted network I/F 7680. In addition, based on acquired information, the microcomputer 7610 may predict danger such as a collision involving the vehicle, an approach by a pedestrian or the like, or entering a closed road and generate a warning signal. For example, the warning signal may be a signal for generating a warning sound or turning on a warning lamp.

The audio/video output portion 7670 transmits an output signal of at least one of sound and an image to an output apparatus that is capable of audibly or visually notifying information to a passenger of the vehicle or to the outside of the vehicle. In an example shown in FIG. 10, an audio speaker 7710, a display portion 7720, and an instrument panel 7730 are exemplified as output apparatuses. For example, the display portion 7720 may include at least one of an on-board display and a head-up display. The display portion 7720 may have an AR (Augmented Reality) display function. The output apparatus may be an apparatus other than those described above such as headphones, a wearable device such as a spectacle type display that is worn by a passenger, a projector, or a lamp. When the output apparatus is a display apparatus, the display apparatus displays, in various formats such as a text, an image, a table, and a graph, results obtained by various types of processing performed by the microcomputer 7610 and information received from other control units. In addition, when the output apparatus is an audio output apparatus, the audio output apparatus converts an audio signal constituted by reproduced speech data or acoustic data into an analog signal and auditorially outputs the converted analog signal.

In the example shown in FIG. 10, at least two control units connected via the communication network 7010 may be integrated as a single control unit. Alternatively, each control unit may be constituted by a plurality of control units. Furthermore, the vehicle control system 7000 may include other control units that are not illustrated. In addition, a part of or all of the functions assumed by any control unit in the description provided above may be shouldered by another control unit. In other words, when information is to be transmitted and received via the communication network 7010, prescribed arithmetic processing may be performed by any control unit. In a similar manner, a sensor or an apparatus connected to any control unit may be connected to another control unit and, at the same time, a plurality of control units may mutually transmit and receive detection information via the communication network 7010.

A computer program for realizing the respective functions of the dashboard camera 1 according to the present embodiment described with reference to FIG. 3 can be implemented in any control unit or the like. In addition, a computer-readable recording medium storing such a computer program can be provided. The recording medium is, for example, a magnetic disk, an optical disk, a magneto-optical disk, or a flash memory. Furthermore, the computer program described above may be distributed via a network or the like without using a recording medium.

In the vehicle control system 7000 described above, the dashboard camera 1 according to the present embodiment described with reference to FIG. 3 can be applied to the external vehicle information detecting unit 7400 according to the application shown in FIG. 10.

In addition, at least a part of the components of the dashboard camera 1 described with reference to FIG. 3 may be realized in a module (for example, an integrated circuit module constituted by a single die) for the integrated control unit 7600 shown in FIG. 10. Alternatively, the dashboard camera 1 described with reference to FIG. 3 may be realized by a plurality of the control units of the vehicle control system 7000 shown in FIG. 10.

### REFERENCE SIGNS LIST

1 Dashboard camera

2 Fisheye lens

4 Control portion

4c Search range setting portion

4d Image encoding portion

6 Vehicle speed sensor

410 Motion vector detecting portion

1. An image processing apparatus, comprising:
a control portion configured to switch, in accordance with a moving speed of a mobile body, search ranges having different motion vectors set in accordance with projection characteristics of a fisheye lens.

2. The image processing apparatus according to claim 1, wherein
an image obtained via the fisheye lens is divided into a plurality of regions in accordance with an angle formed by the mobile body and an object, and the search range of a motion vector is set for each of the regions.

3. The image processing apparatus according to claim 2, wherein
the image is divided into a central part, an intermediate part, and a peripheral part in accordance with an angle formed by the mobile body and the object.

4. The image processing apparatus according to claim 3, wherein
a first search range and a second search range are each set as the search range of a motion vector,
as the first search range, a search range of a motion vector in the peripheral part is set so as to be smaller than a search range of a motion vector in the central part and the intermediate part, and
as the second search range, a search range of a motion vector in the central part and the peripheral part is set so as to be smaller than a search range of a motion vector in the intermediate part.

5. The image processing apparatus according to claim 4, wherein
the control portion is configured to
set the first search range as the search range of a motion vector when a moving speed of the mobile body is a low speed that is lower than a prescribed threshold, and
set the second search range as the search range of a motion vector when the moving speed of the mobile body is a high speed that is higher than the prescribed threshold.

6. The image processing apparatus according to claim 3, wherein
the central part includes an image region where an angle formed by the mobile body and the object is 0 degrees,
the intermediate part includes an image region where an angle formed by the mobile body and the object is 45 degrees, and
the peripheral part includes an image region where an angle formed by the mobile body and the object is 90 degrees.

7. The image processing apparatus according to claim 3, wherein
the image is a rectangular image.

8. The image processing apparatus according to claim 1, wherein
a moving speed of the mobile body is detected using at least one of a vehicle speed sensor and an image obtained via the fisheye lens.

9. An in-vehicle device, comprising:
a fisheye lens;
an image-capturing portion; and
a control portion configured to set a search range for detecting a motion vector based on an image obtained by the fisheye lens and the image-capturing portion, wherein
the control portion is configured to switch, in accordance with a moving speed of a mobile body, different search ranges of a motion vector set in accordance with projection characteristics of the fisheye lens.

10. An image processing method, comprising:
a control portion switching, in accordance with a moving speed of a mobile body, different search ranges of a motion vector set in accordance with projection characteristics of a fisheye lens.

11. A program that causes a computer to execute an image processing method including:
a control portion switching, in accordance with a moving speed of a mobile body, different search ranges of a motion vector set in accordance with projection characteristics of a fisheye lens.
